(19) United States
(12) Patent Application Publication
(10) Pub. No.: US 2014/0359431 A1
(43) Pub. Date: Dec. 4, 2014

(54) EFFECTIVELY COMMUNICATING LARGE PRESENCE DOCUMENTS WITHIN HIGH LATENCY AND LOSSY NETWORK ENVIRONMENTS

(71) Applicant: MOTOROLA SOLUTIONS, INC., SCHAUMBURG, IL (US)

(72) Inventors: Satyanarayana Tummalapenta, Bangalore (IN); Ranjit Avasarala, Bangalore (IN)

(21) Appl. No.: 14/363,374

(22) PCT Filed: Nov. 19, 2012
(86) PCT No.: PCT/US12/65857

§ 371 Date: Jun. 6, 2014

(30) Foreign Application Priority Data
Dec. 12, 2011 (IN) 3607/DEL/2011

(51) Int. Cl. H04L 29/06; G06F 17/22; G06F 17/21

(52) U.S. Cl. CPC H04L 69/04; G06F 17/211; G06F 17/2264
USPC 715/249

(57) ABSTRACT

A presentity (160) within a Presence Information Data Format-compliant data structure (120) can be identified. The structure (120) can be comprised of one or more presence elements (122, 124). The presence elements (122, 124) can be associated with the presentity (160) and/or computing devices (162) linked to the presentity (160). The structure (120) can be recursed to a presence element (122, 124) or an element of an ordered list. Presence information (126, 128) from the presence element (122, 124) or element from an ordered list can be obtained. A master document (130) associated with the presentity (160) can be created. The master document (130) can include reference identifiers (110) for one or more sub-documents (132, 134). A sub-document (132,134) can include its reference identifier, a reference identifier to another sub-document, and presence information (126) associated with the presence element (122, 124).

### FIELD OF THE DISCLOSURE

The present invention relates to the presence services and, more particularly, to effectively communicating large presence documents within high latency and lossy network environments.

### BACKGROUND

Presence information can be information about presentities such as a person or a computing device or a service. Presence information is primarily about the availability of a presentity. Additionally, presence information can contain a person's geographic location, contact information, etc. Presence information is increasingly being utilized to assist Emergency Response Services in real-time. The presence information can enable response personnel to make informed decisions and allow coordinated efforts to be achieved. Typically, presence information can be communicated over one or more wireless networks to network operation centers (e.g., dispatch) and to other devices (e.g., devices used by team members) as a presence document. As presence information can be associated with complex devices, presence documents can become increasingly large in size. For example, a network video recorder can be associated with hundreds of devices, such as cameras, microphones, etc. Consequently, transmission of such large presence documents over high latency and lossy wireless networks can be problematic.

Large presence documents cannot be transmitted using Transmission Control Protocol (TCP) due to the non-real-time nature of TCP. The transmission time may increase abnormally due to TCP significantly reducing the transmission rate when losses occur. Alternately, large presence documents cannot be sent using User Datagram Protocol (UDP) because the documents usually exceed the maximum transmission unit (MTU) size limit of various wireless networks, which is between 600 and 1500 bytes.

Retransmission of lost data can cause additional problems, even for networks having a high MTU size limit. In lossy networks, the probability of having corrupted buts in a packet increases with packet size. These corruptions result in packets being dropped, which causes the sender to retransmit, resulting in increased message traffic that further aggravates the problem. Additionally, in high latency wireless networks, low retransmission timers can result in frequent retransmission of these large documents. For example, Session Initiated Protocol (SIP) technologies utilize retransmission timers which can be low and can cause retransmissions to happen more frequently than necessary. This can result in additional network traffic which can further aggravate the problem. The result is missed notifications that cause the showing of an incorrect status and/or presence notifications taking a longer than acceptable time.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram illustrating a scenario for effectively communicating large presence documents within high latency and lossy network environments in accordance with an embodiment of the inventive arrangements disclosed herein.

FIG. 2 is a flowchart illustrating a method for effectively communicating large presence documents within high latency and lossy network environments in accordance with an embodiment of the inventive arrangements disclosed herein.

FIG. 3 is a schematic diagram illustrating a system for effectively communicating large presence documents within high latency and lossy network environments in accordance with an embodiment of the inventive arrangements disclosed herein.

FIG. 4 is a schematic diagram illustrating a schema extension, a sample master document, and a sample sub-document for effectively communicating large presence documents within high latency and lossy network environments in accordance with an embodiment of the inventive arrangements disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One embodiment of the disclosure provides a solution for effectively communicating large presence documents within high latency and lossy network environments. In the solution, a large presence document can be decomposed into a master document and associated sub-documents. The master document can be constructed to include one or more references to sub-documents which can be associated with presence information (e.g., nested references). In one instance, decomposition can be performed based on a packet size threshold which can maximize the communication probability within lossy environments. In the instance, the master and sub-documents can be chunked into a data size less than or equal to the maximum transmission size of a wireless protocol. In one embodiment, Quality of Service (QoS) attributes can be applied to master and sub-documents to improve delivery impact. For example, a master document having critical presence information can be associated with a high priority QoS attribute. That is, time-sensitive essential presence information can be communicated within high latency networks while minimizing the effect of environmental shortcomings. The master and sub-documents can be communicated to a presence service and/or a watcher via a UDP-based Data Transfer Protocol (UDP). In one embodiment, a traditional Presence Information Document Format (PIDF) compliant presence document can be processed into a master and sub-document data set.

In one embodiment, the PIDF compliant document can include a hierarchy of presence information, which embodiments of the disclosure collapse into data contained within the master document and the sub-documents. For example, the hierarchy of presence information can include a set of nodes having parent-child relationships, which are expressible in a tree-like structure. The topmost node can be a root node, which can have one or more dependent children. This root node can be contained in the master document. One or more child nodes (or sub-child nodes) of the hierarchy or tree-like structure can be included in each sub-document. In one embodiment, collapsing of the hierarchy can shorten the number of nodes in the hierarchy while maintaining the encoded data of the hierarchy. In another embodiment, collapsing the hierarchy can simply refer to decomposing the hierarchy (typically a unified tree-like structure) into a set of discrete documents, which include the master document and the sub-documents(s).

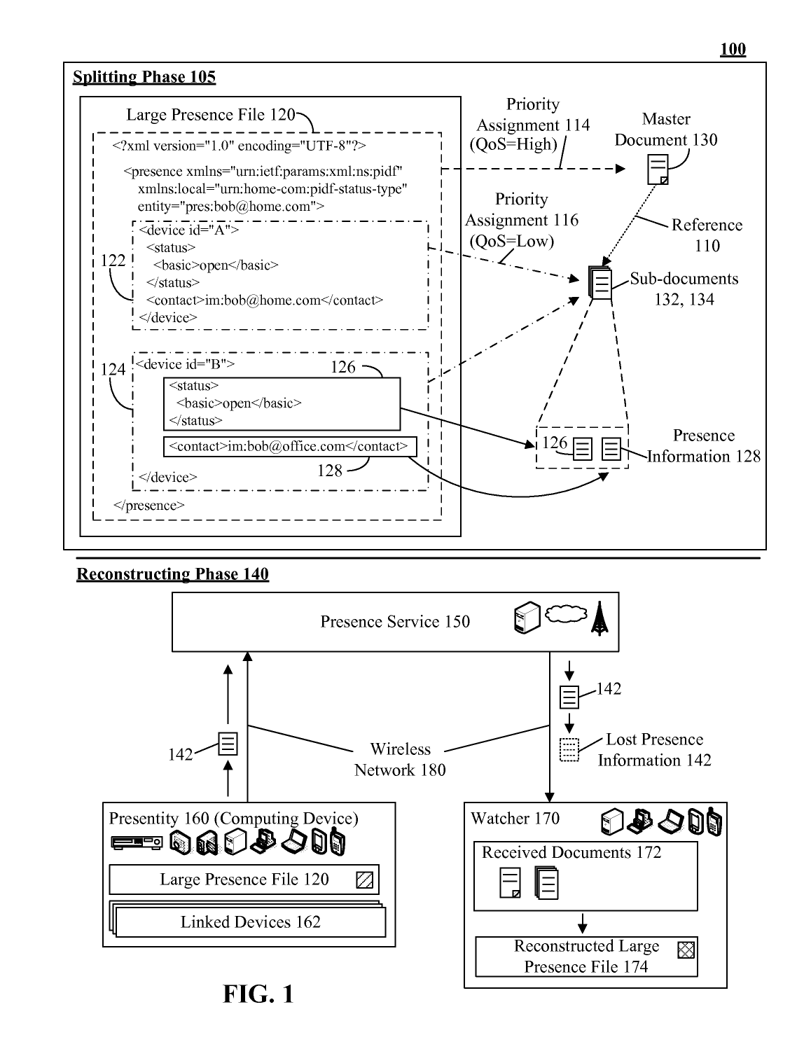

FIG. 1 is a block diagram illustrating a scenario 100 for effectively communicating large presence documents 120 within high latency and lossy network environments 180 in accordance with an embodiment of the inventive arrangements disclosed herein. Scenario 100 can be present in the context of method 200, and/or system 300. Scenario 100 can include two phases: splitting phase 105 and reconstructing phase 140. It should be appreciated that scenario 100 can include optional phases not described herein.

In scenario 100, a PIDF-compliant data structure represented by large presence file 120 (e.g., a presence document) can be created by a presentity 160. The term “presentity” 160, as used herein, can be used to refer to an entity (e.g., computing device, electronic device, group of users, etc.) described by presence information, as described in RFC 2778. The large presence file 120 can be communicated over a wireless network 180 as a master document 130 and one or more dependent sub-documents 132, 134 to a presence service 150 that can act as a central distribution point for presence information. The sub-documents can include presence information 126, 128 describing one or more linked devices 162. The documents, master document 130 and sub-documents 132, 134, can be received by a watcher 170 entity (e.g., received documents 172). The received documents 172 can be utilized to reconstruct the large presence file 120 as reconstructed large presence file 174.

It should be appreciated that one or more sub-documents can be can be “lost” (e.g., lost presence information 142) during transmission without preventing the large presence file 120 from being reconstructed. That is, the disclosure can overcome traditional limitations associated with communicating large presence files 120 within non-optimum transmission environments.

As used herein, large presence file 120 and presence information 126, 128 can include data associated with one or more presentities. Data can be associated with one or more devices, systems, and the like. For example, data can be the status (e.g., busy, idle) of a user utilizing an instant message application. Data can include, but is not limited to, geographic location, availability, state information, device capabilities, contact information, and the like. Data can be associated with one or more presence protocols including, but not limited to, Session Initiation Protocol (SIP), SIP for Instant Messaging and Presence Leveraging Extensions (SIMPLE), Extensible Messaging and Presence Protocol (XMPP), Instant Messaging and Presence Protocol (IMPP), and the like.

In splitting phase 105, a large presence file 120 can be decomposed into a master document 130 and sub-documents 132, 134 based on file structure. For example, phase 105 can leverage a Document Object Model (DOM) to split the file 120 into smaller documents. Large presence file 120 can conform to a Presence Information Data Format (PIDF) which can include elements and/or attributes (e.g., tags) which can describe presence information associated with a presentity. For example, large presence file 120 can include presence elements 122, 124 which can be associated with devices within a presence entity (e.g., linked devices 162). Presence elements 122, 124 can include presence information including, but not limited to, a status 126, contact 128 information, a note, and the like.

In one embodiment, large presence file 120 can be divided into sub-documents which can include one or more items of presence information 126, 128. In the embodiment, each sub-document 132, 134 can include a reference 110 which can be recorded within master document 130. For example, reference 110 within the master document 130 that can allow each portion of presence information 126, 128 from the large presence file 120 to be identified within the sub-document 132 and/or 134. It should be appreciated that file 120 can be decomposed into sub-documents with sizing comparable to a size threshold value. For example, the size threshold value can be less than or equivalent to the maximum transmission size (MTU) of the transmission protocols used by the wireless network 180. That is, limiting sub-document sizes to transmission packets of an MTU size can improve deliverability and decrease retransmissions due to lost packets. Since each sub-document 132, 134 can be limited to a specific size, the size of the sub-document 132, 134 can be assessed, where if the assessed size exceeds the threshold size for the sub-document 132, 134, presence data of the subdocument 132, 134 can be separated into at least one sub-group (or additional sub-document 132, 134, which may be dependent on a “parent” sub-document 132, 134 or on the master document 130).

Sub-document 132, 134 size can be dependent on the quantity of presence information within the document. In one embodiment, sub-document 132, 134 can include, but is not limited to, a status, a characteristic, an attribute, and the like. For example, sub-document 132 can include the status presence element 122 and sub-document 134 can include the contact presence attribute 124.

In one embodiment, the ability to nest presence information 122, 124 and/or presence elements 126, 128 can be supported to enable efficient decomposition and reconstruction of the large presence file 120. The reconstruction (shown by phase 140) of the large presence file 120 can utilize the master document 130 and the sub-documents 132, 134 to reverse the splitting of the original PIDF-compliant presence document 120 to reconstruct the original document (i.e., reconstructed large presence file 174, can be a reconstructed version of the original presence file 120). In one embodiment, during the reconstruction phase 140, the master document (one of the received documents 172) can be considered a top level document written in a PIDF structure, where sub-documents 132-134 (lower-level documents) include other portions of the structure, which are indexed against the master document.

In such an embodiment, sub-documents 132, 134 can each have associated children sub-documents 132, 134. For example, references 110 within a parent sub-document 132, 134 can link to child sub-documents 132, 134. It should be appreciated that sub-documents 132, 134 can lack PIDF compliance.

In one scenario, when the master document 130 size exceeds a size threshold (e.g., a predetermined threshold) value (e.g., MTU), the master document 130 can be divided and can include sub-document references 110. The sub-document references 110 can reference different sub-documents. For example, when the master document 130 is twenty six hundred bytes in size, the master document 130 can be split in half and can include references 110 to two separate thirteen hundred byte size sub-documents 132, 134. Thus, it can be stated that presence data of the original file 120 can be split into presence data placed in the master document 130 and/or the sub-documents 132, 134 responsive to and contingent upon determining that the size of the original presence document (large presence file 120) exceeds the MTU.

Master document 130 and/or sub-documents 132, 134 can be communicated over wireless networks 180. In one embodiment, master document 130 and sub-documents 132, 134 can be conveyed utilizing a UDP-based (User Datagram Protocol) Data Transfer (UDT) protocol. In this embodiment, use of the UDT protocol can permit rapid communication of the master document 130 and/or sub-documents 132, 134 without significantly increasing communication overhead. It should be appreciated that the use of the UDT protocol can accommodate the time sensitive nature of presence data which can suffer from traditional (e.g., stateful) protocols such as Transport Control Protocol (TCP).

To improve transmission and reception probability within lossy and/or high latency environments, Quality of Service attributes can be assigned to the master document 130 and/or sub-documents 132, 134. For example, the master document 130 can be assigned a high priority assignment 114 due to its pivotal role in the reconstruction phase 140. In one instance, sub-documents 132, 134 associated with the presentity 160 and/or related entities (e.g., linked devices 162) with non-critical priority can be prioritized appropriately. For example, a sub-document 132, 134 pertaining to a non-critical Device A can be assigned a low priority assignment 116. In another instance, presence data can be omitted from the splitting 105 and/or reconstructing phases 140. For example, a sub-document 132, 134 containing presence information about a non-operational device can be omitted from a sub-document.

In reconstructing phase 140, presence file 120 can be communicated as master document 130 and sub-documents 132, 134 to a watcher 170. It should be understood that master document 130 and sub-documents 132, 134 can be payload data of a protocol packet. For example, sub-document 132, 134 can be payload data of a UDT packet. Communication of document 130 and/or sub-documents 132, 134 can occur in real-time or near real-time.

In one instance, lost presence information 142 can be communicated from the presentity 160 and not be received by watcher 170. The information 142 can be lost based on one or more conditions including, checksum errors, network errors, network timeout, and the like. Watcher 170 can reconstruct the large presence file 120 as file 174 utilizing available data within received documents 172. That is, permitting a significant portion of the large presence file 120 is received, presence information about presentity 160 can be determined.

For example, watcher 170 can perform composition actions to determine the state of a linked device 162 for which no presence information can be available. The reconstructing phase 140 can be performed in the presence of missing sub-documents and can be facilitated by intelligent selection and/or transmission of sub-documents. It should be appreciated that scenarios where all sub-documents 132, 134 are received can result in the large presence file 120 being reconstructed by the watcher 170 as file 172. It should be appreciated that the disclosure can support fragmenting discrete data to remove dependencies. The fragments can be transmitted independently, allowing an acceptable loss of one or more fragments whose loss minimally impacts the recovery of other fragments.

Thus, the watcher 170 and/or presence service 150 can ascertain a completeness (or lack thereof) of the copy of the original PIDF compliant presence document (large presence file 120). In one embodiment, this completeness can be performed by a quantitative comparison of a size of a copy of the original PIDF compliant presence document (file 120) and an expected size, where the expected size can be defined within the master document 130. Thus, if the size of the reconstructed presence file 174 or portions thereof is less than the expected size, as noted in the master document 130 (or sub-documents for sub-portions of the presence data), the presence service 150/watcher 170 can ascertain that at least a portion of the presence file 120 was not properly conveyed over a network (e.g., wireless network 180). In one embodiment, a completeness level can be ascertained and compared against a predetermined threshold value representing a minimum acceptable size of the copy of the original PIDF compliant document (file 120). If/when the threshold is satisfied, the watcher 170 can use the received (albeit imperfect) copy of the file 174. If/when the predetermined threshold is unsatisfied, the watcher 170 can re-request the original PIDF complaint presence document (or portion thereof) from a transmitting presentity 160.

Drawings presented herein are for illustrative purposes only and should not be construed to limit the invention in any regard. It should be understood that presence service 150, presentity 160, and watcher 170 can conform to specifications described within RFC2778 and/or RFC3859. As it is known in the art, RFC2778 can describe a model for presence and instant messaging, while RFC3859 can teach a common profile for presence (CPP).

As used herein, a large presence file 120 can be include a file exceeding the maximum transmission unit (MTU) size of a wireless network 180, a file exceeding a size threshold value, and the like. Components 150, 160, 170 can conform to a publish/subscribe architecture.

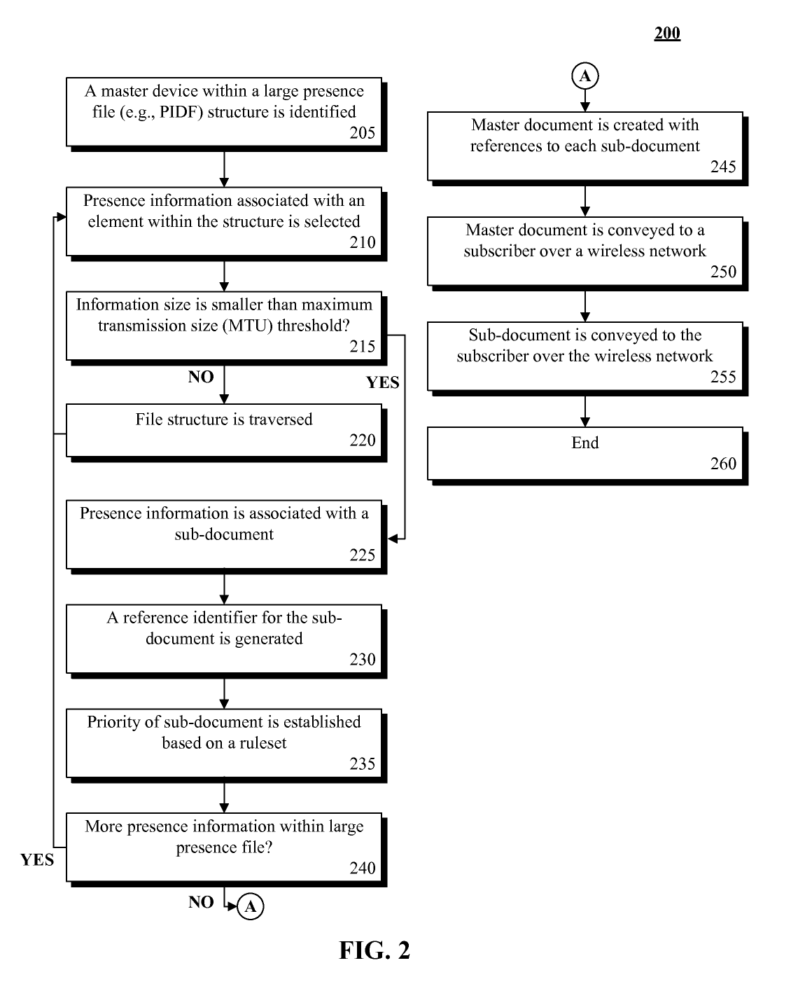

FIG. 2 is a flowchart illustrating a method 200 for effectively communicating large presence documents within high latency and lossy network environments in accordance with an embodiment of the inventive arrangements disclosed herein. Method 200 can be performed within scenario 100 and/or system 300. In method 200, a large presence file to be communicated over a wireless network can be identified. The large presence file can be decomposed into a master document and dependent sub-documents. The size of the master document and sub-document can be tailored to maximize transmission likelihood. Further, Quality of Service (QoS) parameters (e.g., priority) can be utilized to improve transmission probability. In one instance, Differentiated Services (e.g., diffserv) mechanisms can be utilized to enable low latency transmission of documents. In the embodiment, Differentiated Services Code Point (DSCP) can be assigned to documents based on the document type. The master document and sub-document can be conveyed over one or more wireless networks to a receiving entity.

In step 205, a master device within a large presence file structure can be identified. For example, the large presence file can be a presence file generated by a network video recorder system. In step 210, presence information associated with an element within the structure can be selected. An element can include, but is not limited to, a status, a characteristic, an attribute, and the like. In step 215, if information size is smaller than a maximum transmission size (MTU) threshold, the method can proceed to step 225, else continue to step 220. In one embodiment, the MTU threshold value can be thirteen hundred bytes. It should be appreciated that the MTU threshold can be easily replaced with a size threshold value which can be utilized to maximize communication of the file. In step 220, the file structure can be traversed. Traversal can be performed utilizing traditional and/or proprietary algorithms. For example, a recursive algorithm can be utilized to parse the large presence file for decomposition within the method 200. For example, the algorithm can recuse through a structure of the large presence file to obtain presence information from a set of structured presence elements or a set of elements organized in an ordered list. This obtained presence information can be used to create the master document and/or the sub-document(s).

In step 225, presence information can be associated with a sub-document. For example, a sub-document can be generated to store presence information for communication. In step 230, a reference identifier for the sub-document can be generated. The reference identifier can be generated utilizing proprietary and/or traditional techniques. The reference identifier can include, but is not limited to, an alphanumeric identifier, a numeric identifier, and the like. In one embodiment, the reference identifier can be a unique identifier associated with the sub-document.

In step 235, the Quality of Service priority of the sub-document can be established based on a ruleset. The priority can conform to one or more QoS capabilities including, but not limited to, rate limiting, scheduling, congestion avoidance, and the like. In step 240, if there is more presence information within the file, the method can return to step 210, else continue to step 245. In step 245, a master document can be created with references to each sub-document within the method. The references can link each sub-document to the master document. The references can be utilized for sub-document tracking, ordering, and the like.

In step 250, the master document can be conveyed to a subscriber over a wireless network. The subscriber can be a watcher, a presence service, a presence application resource, and the like. In step 255, each sub-document can be conveyed to the subscriber over the wireless network. For example, each sub-document can be conveyed to the subscriber using separate communication messages. In one embodiment, the master and/or sub-document can be communicated to a subscriber via a NOTIFY message. In the embodiment, the NOTIFY message can conform to a Request For Comments 3856 (RFC3856) specification. In one embodiment (shown by step 250 and 255) the master document and each sub-document can be independently conveyed in separate communication messages. Each of these communication messages can include a new media type designation to indicate an existence of sub-document reference identifiers. That is, a parent document can include a reference to child documents (where the child documents include nodes dependent upon nodes of the parent document in accordance with an overall hierarchy or tree-like structure—as expressed by the original presence document and/or as expressed by the aggregate of the master document and sub-documents). In step 260, the method can end.

Drawings presented herein are for illustrative purposes only and should not be construed to limit the invention in any regard. It should be understood that the method can be performed in serial and/or in parallel. The method can be performed in real-time or near real-time. The method can include optional steps not described herein. In one embodiment, the method 200 can be a functionality of MOTOROLA REAL-TIME VIDEO INTELLIGENCE software.

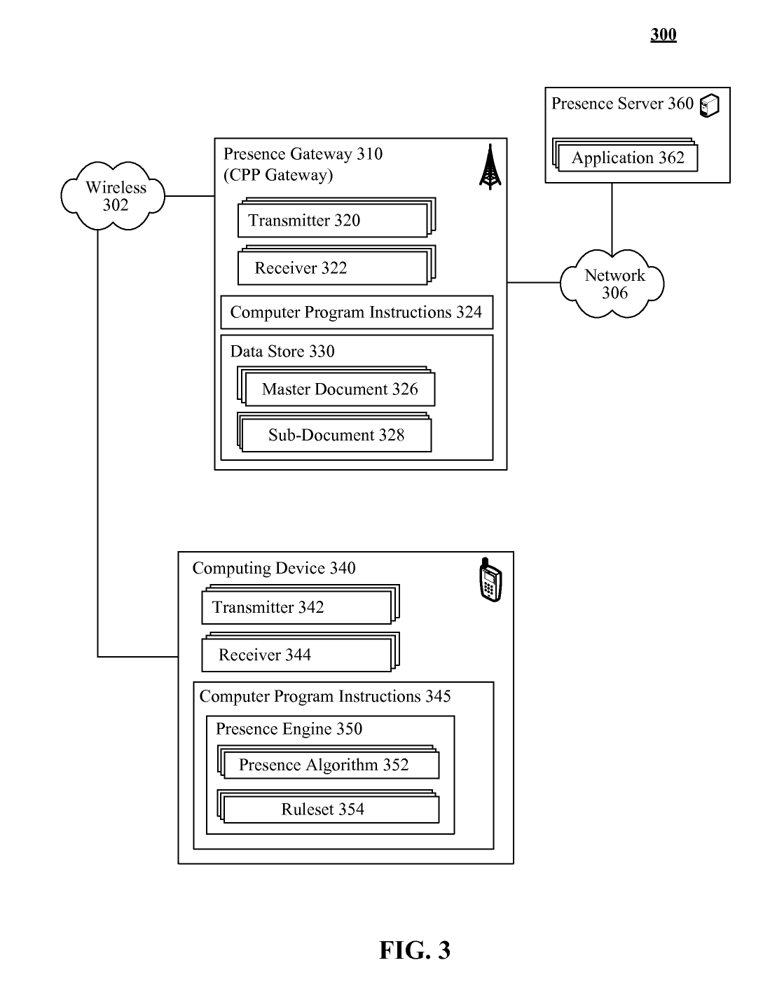

FIG. 3 is a schematic diagram illustrating a system for effectively communicating large presence documents within high latency and lossy network environments in accordance with an embodiment of the inventive arrangements disclosed herein. System 300 can be performed in the context of scenario 100 and/or method 200. In system 300, a presence gateway 310 can communicate with a presence server 360 and a computing device 340 via network 306 and wireless network 302. Presence information conforming to a master document 326 and a sub-document 328 can be available to application 362 and device 340 via gateway 310.

Gateway 310 can be a common gateway interface for communicating presence data between server 360 and one or more computing devices 340. Gateway 310 functionality can include, but is not limited to, presence information dissemination, subscription management, security management, and the like. Gateway 310 can include, but is not limited to transmitter 320, receiver 322, computer program instructions 324, data store 330, and the like. In one embodiment gateway 310 can conform to a Common Profile for Presence (CPP) gateway.

Computing device 340 can be a hardware/software entity including at least one wireless transmitter 342 and wireless receiver 344, which allows the device 340 to connect to wireless network 302. Additional (and optional) receivers and/or transmitters can be included in device 340. The device 340 can include one or more processor and one or more memory components (not shown). The set of one or more processors can execute computer program instructions 345 of the device 340. These instructions 345 can represent logic embedded in semiconductor, firmware embedded instructions, and/or software stored on a storage medium of device 340, such as memory. Program instructions 350 can include presence engine 350. In one embodiment, instructions 345 can be present within a communication stack of a device 340.

Presence engine 350 can be a hardware/software element able to permit communication of presence information from device 340 to gateway 310 and/or presence server 360. The presence engine 350 can include, but is not limited to, presence algorithm 352, ruleset 354, and the like. Presence engine 350 functionality can include, but is not limited to, presence state determination, text message processing, call control, and the like.

Presence algorithm 354 can be a set of instructions for decomposing, and/or recomposing presence information (e.g., master document 326, sub-documents 328) regarding other computing devices (not shown) connected to the networks 302 and/or 306. Algorithm 352 can include traditional and/or proprietary algorithms. Algorithm 352 functionality can include, tree traversal functionality (e.g., Document Object Model (DOM) navigation), chunking capabilities, and the like. For example, algorithm 352 can be utilized to calculate the number of sub-documents 328 necessary for communicating a large presence file, such as the large presence file 120 of FIG. 1. In one embodiment, algorithm 352 can utilize a table mechanism (e.g., database table) for tracking and/or ordering master document 326 and sub-documents 328.

Ruleset 354 can be one or more rules for establishing the behavior of presence engine 350 and/or algorithm 352. Ruleset 354 can include, but is not limited to, one or more threshold values, programmable actions, triggers, and the like. Ruleset 354 can include wireless 302 network-specific rules, location-specific rules, and the like. In one embodiment, ruleset 354 can include assignable profiles. For example, ruleset 354 can have individualized profiles for each application 362.

Presence server 360 can be a hardware/software element able to execute application 362. Server 360 can include, but is not limited to, application 362, application 362 settings, and the like. Application 362 can be a software program able to process presence information associated with computing device 340. Application 362 functionality can include, but is not limited to, presence monitoring, resource coordination, and the like. For example, application 362 can be a public safety dispatch application utilized by dispatch personnel.

The wireless network 302 can be used convey digitally encoded information wirelessly between mobile devices. In various embodiments, wireless network 302 can conform to a variety of wireless communication technologies, such as Global System for Mobile Communications (GSM), Code division multiple access (CDMA), Wireless local loop (WLL), a wide area network (WAN), WiFi (any of the IEEE 802.11 family of standards), WiMAX (Worldwide Interoperability for Microwave Access), etc. In one embodiment, the wireless network 302 can be 3GPP compliant. In one embodiment, wireless network 302 can include a LTE network.

Network 306 can represent a packet-switched network. Network 306 can conform to the internet protocol (IP) set of protocols that include a Transmission Control Protocol (TCP) and the Internet Protocol. Network 306 can be public or private. For example network 306 can represent the public Internet, a corporate intranet, a virtual private network (VPN), and the like. Data and/or voice (via Voice over IP) can be conveyed over network 306.

Data store 330 can be a hardware/software component able to store master document 326 and/or sub-document 328. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to gateway 310 in one or more traditional and/or proprietary mechanisms.

Drawings presented herein are for illustrative purposes only and should not be construed to limit the invention in any regard. In one embodiment, presence engine 350 can be a functionality of an Application Programming Interface (API).

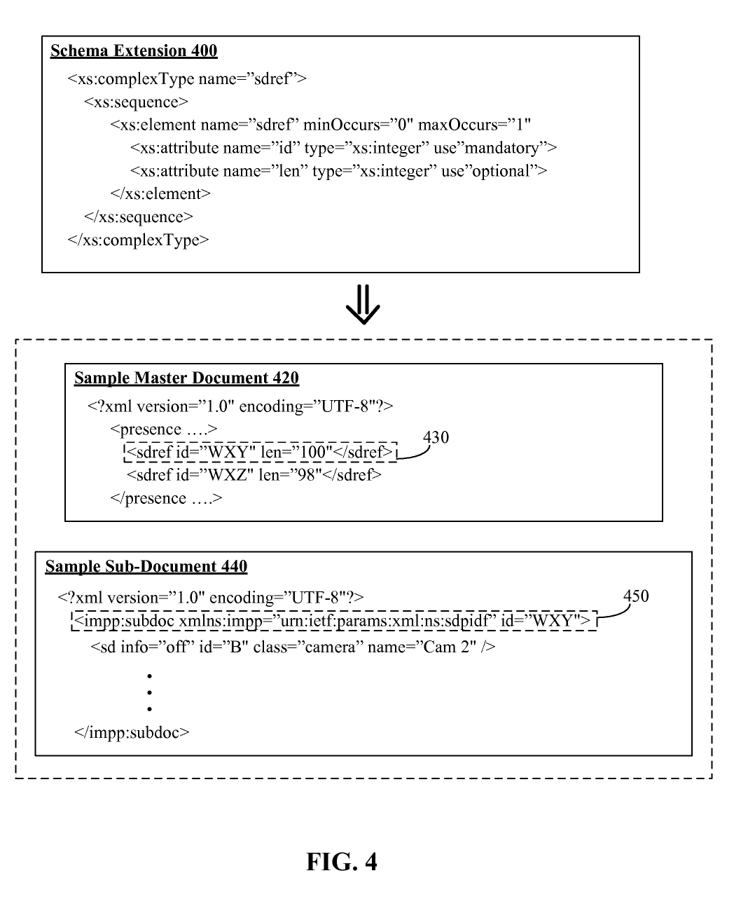

FIG. 4 is a schematic diagram illustrating a schema extension 400, a sample master document 420, and a sample sub-document 440 for effectively communicating large presence documents within high latency and lossy network environments in accordance with an embodiment of the inventive arrangements disclosed herein. Schema extension 400, sample master document 420, and sample sub-document 440 can be present in the context of scenario 100, method 200, and/or system 300.

Schema extension 400 can be utilized to define a new extension within the existing namespace of a Presence Information Data Format (PIDF) schema. For example, extension 400 can be a portion of a Document Type Definition (DTD) of a PIDF schema.

In one embodiment, the extension 400 can define a complex data type for enabling the disclosure functionality. In the embodiment, the extension 400 can include a sequence, an element, and/or multiple attributes for establishing references described herein.

Sample master document 420 can be an Extensible Markup Language (XML) document conforming to PIDF. Master document 420 can include a reference identifier 430 linking the master document 420 to sub-document 440. For example, master document 420 can include element “sdref” with an identifier 430 (e.g., “WXY”) and a length indicating the size of an associated sub-document. In one instance, the master document 420 can be associated with an application/pidf-sdref+xml Multipurpose Internet Mail Extension (MIME) type. In the instance, the use of the MIME type can indicate the presence of sub-document references associated with a master document.

Sample sub-document 440 can be a XML document including presence information associated with a presentity. The sub-document 440 can include a reference identifier linking master document 420 to the sub-document 440. For example, sub-document 440 can include a “subdoc” element 450 which can specify the sub-document namespace and reference identifier. Sub-document 440 can be well-formed as per the World Wide Web Consortium (W3C) specification XML 1.0.

It should be appreciated that schema extension 400 can represent one embodiment of a schema extension enabling disclosure capabilities. Further, it should be understood that sample master document 420 and sample sub-document 440 can represent exemplary documents utilized within the disclosure. That is, document 420 and/or sub-document 440 is not an exhaustive illustration and the syntax and/or contents of the document 420 and/or sub-document 440 can vary based on implementation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for collapsing a hierarchy within a presence information data format document comprising:
selecting a presence document associated with a top level computing device, person, or service within a hierarchy, wherein the presence document conforms to a Presence Information Data Format (PIDF) schema;
identifying independent presence information within the presence document that is separated as sub-documents; and
assigning a reference identifier to each sub-document and recording the reference identifier to each sub-document within a master document.

2. The method of claim 1, wherein the size in bytes of the presence document exceeds thirteen hundred bytes, wherein each of the sub-documents and of the master document is between six hundred to thirteen hundred bytes.

3. The method of claim 1, further comprising:
identifying a top level document for the presence document, wherein the presence document is in a Presence Information Data Format (PIDF) compliant data structure, wherein the structure is comprised of a plurality of elements, wherein the plurality of elements is associated with the sub-documents;
recursing through the structure to at least one of a presence element and an element of an ordered list;
obtaining presence information from the at least one presence element and the element of the ordered list; and
creating the master document that comprises at least one of a reference identifier and a reference to one or more of the sub-documents, wherein each of the subdocuments comprises the at least one of a reference identifier, a reference to another one of the sub-documents, and presence information associated with at least one of a presence element and an element of an ordered list.

4. The method of claim 1, further comprising:
obtaining the presence document, which exceeds a maximum transmission unit (MTU) size of a communications protocol of a network over which the presence document is to be transmitted; and
splitting the presence data of the presence document into the master document and the sub-documents, wherein a size of the master document and the size of each of the subdocuments are less than or equal to the maximum transmission unit (MTU) size of the communications protocol.

5. The method of claim 3, further comprising:
independently conveying the master document and each of the subdocuments over the network within separate communication messages.

6. A system for conveying presence information over a wireless network comprising:
a presence algorithm configured to collapse a hierarchy of a PIDF document associated with a computing device into a master document and at least one sub-document, wherein the master document comprises at least one of a reference identifier and a reference to a sub-document, wherein the sub-document comprises the at least one of a reference identifier and a presence information;
a presence engine able to convey the master document and the at least one sub-document to a network server within a NOTIFY message via a wireless network;
a ruleset configured to determine the size of the master document and the at least one sub-document; and
a scheme to reconstruct the original presence document from the master document and at least one sub-document.

7. The system of claim 6, wherein the presence algorithm is triggered when the PIDF document exceeds a maximum transmission unit (MTU) size of a communications protocol of a network over which the PIDF document is to be transmitted, wherein a size of the master document and the size of each of the at least one subdocument are less than or equal to the maximum transmission unit (MTU) size of the communications protocol.

8. The system of claim 6, wherein the presence information is associated with at a SIP for Instant Messaging and Presence Leveraging Extensions (SIMPLE).

9. The system of claim 6, wherein the size in bytes of each of the at least one sub-document and of the master document is between six hundred to thirteen hundred bytes.

10. The system of claim 6, further comprising:
an extension to the Presence Information Data Format comprising of a ComplexType element, wherein ComplexType element comprises a sequence, wherein the sequence is an element having at least one identifier attribute.

11. A method for improving the transmission of large presence files comprising:
obtaining a presence document, which exceeds a maximum transmission unit (MTU) size of a communications protocol of a network over which the presence document is to be transmitted;
splitting the presence data of the presence document into the master document and the sub-documents, wherein a size of the master document and the size of each of the subdocuments are less than or equal to the maximum transmission unit (MTU) size of the communications protocol; and
independently conveying the master document and each of the subdocuments over the network within separate communication messages.

12. The method of claim 11, wherein the presence document is associated with a top level computing device, person, or service within a hierarchy, wherein the presence document conforms to a Presence Information Data Format (PIDF) schema, said method further comprising:
identifying independent presence information within the presence document that is separated into the subdocuments in the splitting step; and
assigning a reference identifier to each of the subdocuments and recording the reference identifier to each of the subdocuments within the master document.

13. The method of claim 11, wherein the obtained presence document is an original Presence Information Data Format (PIDF)-compliant presence document having presence data associated with a presentity operating in the network having data transmissions that experience at least one of high latency and lossiness by a presence engine operating on the presentity.

14. The method of claim 13, further comprising:
determining that a size of the original PIDF-compliant presence document exceeds a maximum transmission unit (MTU) of a communications protocol used within the network and splitting the presence data into the master document and the sub-documents responsive to and contingent upon the determining that the size of the original presence document exceeds the MTU.

15. The method of claim 11, wherein the presence document is an original Presence Information Data Format (PIDF)-compliant presence document, wherein the master document and the at least one sub-document utilize a PIDF schema extension that allows the presence data of the original PIDF-compliant presence document to be represented hierarchically with the master document as a root node to which the at least one sub-document relate in a tree-like structure, wherein the master document contains reference identifiers for sub-documents that are its direct children, wherein a reference identifier uniquely identifies a sub-document, wherein each sub-document represents an independent segment of the original PIDF-compliant presence document.

16. The method of claim 11, wherein the independently conveying the master document and each of the subdocuments further comprises:
independently conveying of the master document and each sub-document in separate communications messages to the presence engine operating on a watcher entity in the network environment by the presence engine of the presentity, wherein each communications message includes a new media type designation to indicate an existence of sub-document reference identifiers.

17. The method of claim 11, wherein the presence document is an original Presence Information Data Format (PIDF)-compliant presence document, wherein method further comprises:
reconstructing of a copy of the original PIDF-compliant presence document from the conveyed communications messages by a presence engine of a watcher entity, wherein said reconstruction utilizes the master document and the at least one sub-document contained in the conveyed communications messages to reverse the splitting of the original PIDF-compliant presence document.

18. The method of claim 12, wherein splitting of the presence document further comprises:
creating the master document for the presentity;
separating the presence data of the original PIDF-compliant presence document into at least one independent logical group;
creating a sub-document for each independent logical group;
assigning the reference identifier to each sub-document; and
recording the reference identifier of each sub-document within the master document.

19. The method of claim 18, wherein creating the sub-document further comprises:
assessing the size of the sub-document;
when the assessed size of the sub-document exceeds the MTU of the communications protocol, separating the presence data of the sub-document into at least one sub-group;
creating sub-documents for the at least one sub-group;
assigning the reference identifier to each sub-document created for the at least one sub-group;
recording the reference identifier of each sub-document created for the at least one sub-group within the assessed sub-document, wherein a parent-child relationship is established between the assessed sub-document and sub-documents created for the at least one sub-group;
recursively repeating the assessment for each sub-document created for the at least one sub-group; and
when the assessed size of the sub-document is less than the MTU of the communications protocol, continuing with the assigning and recording of the reference identifier of the assessed sub-document within the master document.

20. The method of claim 17, wherein, when at least one communications message conveying a sub-document is lost, reconstructing the copy of the original PIDF-compliant presence document further comprises:
ascertaining a completeness of the copy of the original PIDF-compliant presence document, wherein the completeness is a quantitative comparison of a size of the copy of the original PIDF-compliant presence document and an expected size, wherein the expected size is defined within the master document for the original PIDF-compliant presence document;
comparing the ascertained completeness to a predetermined threshold value representing a minimum acceptable size for the copy of the original PIDF-compliant presence document;
when the predetermined threshold value is satisfied, allowing the copy of the original PIDF-compliant presence document to be used by the watcher entity; and
when the predetermined threshold value is unsatisfied, re-requesting the original PIDF-compliant presence document from the presentity.
